(19) United States
(12) Patent Application Publication
(10) Pub. No.: US 2010/0162975 A1
(43) Pub. Date: Jul. 1, 2010

(54) LASH ADJUSTMENT BETWEEN ROLLERS AND A CAM PLATE OF A BARREL ENGINE

(75) Inventors: Jay Michael Larson, Marshall, MI (US); C. Russell Thomas, Boulder, CO (US)

Correspondence Address: GIFFORD, KRASS, SPRINKLE,ANDERSON & CITKOWSKI, P.C, PO BOX 7021, TROY, MI, 48007-7021, US

(73) Assignee: Thomas Engine Company, LLC, Boulder, CO (US)

(21) Appl. No.: 12/722,854

(22) Filed: Mar. 12, 2010

Related U.S. Application Data
(63) Continuation-in-part of application No. 11/360,779, filed on Feb. 23, 2006, now abandoned.
(60) Provisional application No. 60/656,017, filed on Feb. 24, 2005.

(51) Int. Cl. F02B 75/26

(52) U.S. Cl. 123/56.3

(57) ABSTRACT

A lash adjustment system for a roller is provided which includes a cam plate surface and a frustoconically shaped roller in mechanical communication with the surface. Means for moving the roller relative to the surface are included to urge the roller inwardly with respect to the cam plate in order to reduce lash.

### REFERENCE TO RELATED APPLICATION

This application is a continuation-in-part of U.S. patent application Ser. No. 11/360,779, filed Feb. 23, 2006, which claims priority from U.S. Provisional Patent Application Ser. No. 60/656,017, filed Feb. 24, 2005, the entire contents of both of which are incorporated herein by reference.

### FIELD OF THE INVENTION

The present invention generally relates to engines that include one or more rollers that roll along a surface, and more particularly, to methods and apparatus for reduction of lash between such a roller and surface.

### BACKGROUND OF THE INVENTION

Cam plate barrel engines utilize a drive means that consists of a plate with an undulating cam surface normally capable of reciprocating all pistons through four or more strokes per one revolution of the driveshaft. A piston in a cam plate barrel engine generally communicates with the cam plate via a pair of rolling elements that follow the undulating surface of the cam plate.

In a typical arrangement, a cylindrical or tapered roller is in rotational engagement with a cam plate track. The cam plate track usually has a generally rectangular or tapered cross-sectional geometry. Tapered rollers are configured such that one is on each side of the cam plate track with the smaller roller radius pointed in the direction of the center of the cam plate. Because of the high reciprocating impact stresses created by the pistons, which are rigidly attached to a cross head containing the two rollers, it is important that the rollers are adjusted to minimize any space between the rollers and the cam plate. This must be done to insure that the impact stresses at the roller/cam plate interface are minimized to avoid detrimental hertzian forces that can cause spalling at this interface. However, it is critical that the rollers do not create high pinching stresses on the cam plate such that excessive friction occurs at the interfaces between the rollers and the cam plate. This may be accomplished mechanically by manually adjusting the optimum distance between the rollers and the cam plate, and can be referred to as setting the “lash” at the interface.

Manually setting lash has several drawbacks. It is difficult to do in a confined space and is subject to human error. Also, as the engine operates at various different conditions, local temperatures within the engine vary, resulting in thermal expansion in the components. This changes the lash from the optimum value at the roller/cam plate interface. Additionally, the roller/cam plate interface is subject to wear as a function of engine operation time, which can also increase the lash from its optimum value. As such, there is a need for apparatus and methods for automatically adjusting lash at the roller/cam plate interface.

### SUMMARY OF THE INVENTION

A lash adjustment system for a roller is provided which includes a cam plate having a first surface, a frustoconically shaped roller in mechanical communication with the first surface and means for moving the roller relative to the surface.

In one embodiment, a provided lash adjustment system for a roller includes a cam plate having a track portion for a roller. The track portion of the cam plate has a first surface, a second surface, a thickness between the first and second surface, an inner side, an outer side, and a width between the inner side and the outer side. A first roller is in mechanical communication with the first surface of a cam plate track portion to allow rotational engagement of a roller surface with the first surface of the cam plate track portion. The first roller has a rotational axis and a frustoconical shape which defines a base and a top of the roller, the base having a larger cross-sectional diameter than the top portion. An inventive system further includes a force applying means for moving the first roller towards the inner side of the cam plate.

Optionally, the thickness of the cam plate track portion is substantially uniform along the width between the inner side and outer side. In a further option, this thickness varies along the width as described in more detail below.

In one embodiment, the first frustoconically shaped roller has its base positioned closer to the outer side of the cam plate track portion relative to its top which is closer to the inner side of the cam plate track portion. The roller surface of the first roller is positioned such that it is substantially parallel to the first surface of the cam plate track portion. The rotational axis of the first roller is not parallel to the first surface of the cam plate track portion surface in such an embodiment.

In a further option, the first frustoconically shaped roller is oriented such that its top is closer to the outer side of the cam plate track portion and its base is closer to the inner side of the cam plate track portion. Again, the first roller surface is positioned substantially parallel to the first surface of the cam plate track portion surface, while the rotational axis of the first roller is not parallel to the first surface of the cam plate track portion surface.

Also provided is a system according to the present invention in which the thickness of the cam plate track portion proximal to the outer side is smaller than the thickness of the cam plate track portion proximal to the inner side. Alternatively, the thickness of the cam plate track portion proximal to the inner side is smaller than the thickness of the cam plate track portion proximal to the outer side.

In a preferred embodiment, a second roller is provided which is in mechanical communication with the second surface of a cam plate track portion to allow rotational engagement of a roller surface of the second roller with the second surface of the cam plate track portion. The second roller has a rotational axis and a frustoconical shape defining a base having a larger crass-sectional diameter than the top.

Force applying means are included for moving the second roller towards the inner side of the cam plate.

Optionally, the second frustoconically shaped roller has a base proximal to the outer side of the cam plate track portion and the top proximal to the inner side of the cam plate track portion. The second roller surface is positioned substantially parallel to the second cam plate track portion surface, and the rotational axis of the second roller is not parallel to the second cam plate track portion surface.

Also provided is an option in which a second frustoconically shaped roller has a top closer to the outer side of the cam plate track portion and a base proximal to the inner side of the cam plate track portion. The second roller surface is positioned substantially parallel to the second cam plate track portion surface and the rotational axis of the second roller is not parallel to the second cam plate track portion surface.

Further optionally, where two rollers are included as described, the thickness of the cam plate track may be substantially uniform along the width between the inner side and outer side or, alternatively, may vary along the width. For example, in one embodiment, the thickness of the cam plate track portion proximal to the outer side is smaller than the thickness of the cam plate track portion proximal to the inner side. The opposite configuration is also provided, that is, in which the thickness of the cam plate track portion proximal to the inner side is smaller than the thickness of the cam plate track portion proximal to the outer side.

An inventive system including a first and second rollers is detailed in which the rotational axis of the first roller is substantially parallel to the rotational axis of the second roller. Such a configuration is a preferred option where the thickness of the cam plate track portion is not uniform along its width.

In one embodiment of an inventive system, a force applying means for moving the first roller towards the inner side of the cam plate is configured to apply force along the rotational axis of the first roller and/or second roller.

The force applying means for moving the first and second rollers may be configured to apply force to the rollers independently of each other. A separate force applying means may be used for each roller in one embodiment.

Further provided for optional inclusion in an inventive system is a support structure for housing the first and/or second roller. One or more force applying means may be disposed on the support structure for applying force to one or more rollers.

In a further embodiment, a method according to the present invention is provided for reduction of lash between a roller and a surface. An embodiment of such a method includes providing a system including a cam plate having a track portion for a roller, the track portion having a first surface, a second surface, a thickness between the first and second surface, an inner side, an outer side, and a width between the inner side and the outer side; a first roller in mechanical communication with the first surface of a cam plate track portion to allow rotational engagement of a roller surface with the first surface of the cam plate track portion, the first roller having a rotational axis and a frustoconical shape; and force applying means for moving the first roller towards the inner side of the cam plate, wherein lash is present between the first roller and the first surface of the cam plate. An inventive method further includes applying force to a first roller, moving the first roller towards the inner side of the cam plate, such that lash between the first roller and the first surface of the cam plate is reduced.

Other embodiments of an inventive method include applying force to a second roller, moving the second roller towards the inner side of the cam plate, where the provided system further comprises a second roller in mechanical communication with the second surface of a cam plate track portion to allow rotational engagement of a roller surface of the second roller with the second surface of the cam plate track portion, the second roller having a rotational axis and a frustoconical shape, and force applying means for moving the second roller towards the inner side of the cam plate, such that lash between the second roller and the second surface of the cam plate is reduced.

In a further embodiment, a lash adjustment system for a roller is provided which includes a cam plate having a track portion for a roller, the track portion having a first surface, a second surface, a thickness between the first and second surface, an inner side, an outer side, and a width between the inner side and the outer side, wherein the inner side and outer side are substantially parallel. A first roller is provided which is in mechanical communication with the first surface of a cam plate track portion to allow rotational engagement of a roller surface with the first surface of the cam plate track portion. The first roller has a rotational axis and a frustoconical shape defining a base portion of the first roller having a larger cross-sectional diameter compared to a top portion of the first roller. The rotational axis of the first roller is not perpendicular to the inner and outer sides. Optionally, such an embodiment also includes a force applying means for moving the first roller towards the inner side of the cam plate.

In a further option, a second roller in mechanical communication with the second surface of a cam plate track portion is provided to allow rotational engagement of a roller surface of the second roller with the second surface of the cam plate track portion. The second roller also has a rotational axis and a frustoconical shape defining a base portion of the second roller having a larger cross-sectional diameter compared to a top portion of the second roller, wherein the rotational axis of the second roller is not perpendicular to the inner and outer sides. A force applying means for moving the second roller towards the inner side of the cam plate is optional.

### BRIEF DESCRIPTION OF THE DRAWINGS

FIG. 1 is a partial sectional view illustrating a generalized engine including a cam plate and adjacent rollers;

FIG. 2 is a perspective view of a cam plate and adjacent rollers;

FIG. 3 is a sectional view of a cam plate and rollers;

FIG. 4 is a sectional view of an inventive design for lash compensation illustrating a cam plate and rollers;

FIG. 5 is a sectional view of an inventive design for lash compensation illustrating a cam plate and rollers;

FIG. 6 is a sectional view of an inventive design for lash compensation illustrating a cam plate and rollers;

FIG. 7 is a top view of an inventive design for lash compensation illustrating a track portion of a cam plate with a roller in contact with the surface of the track;

FIG. 8 is a perspective view of an inventive configuration of a cam plate and adjacent rollers;

FIG. 9 is a cross-sectional view of a portion of a roller and an example of a force applying mechanism for moving the roller to reduce lash; and

FIG. 10 is a detailed view of the hydraulic actuator that forms part of the force applying mechanism of FIG. 9.

### DETAILED DESCRIPTION OF THE INVENTION

This application is related to engines that include rollers that roll along a surface, such as shown in U.S. Pat. No. 6,986,342, the entire content of which is incorporated herein by reference. As discussed in that, and other of Applicant's applications and patents, engines such as a barrel engine may include a cam plate with an oscillating track in mechanical communication with pistons such that as the pistons reciprocate within cylinders as the plate rotates. Communication between the surface of the cam plate and the pistons requires some type of sliding or roller mechanism. The present application is directed towards rollers for providing such a communication, and lash adjustment for those rollers.

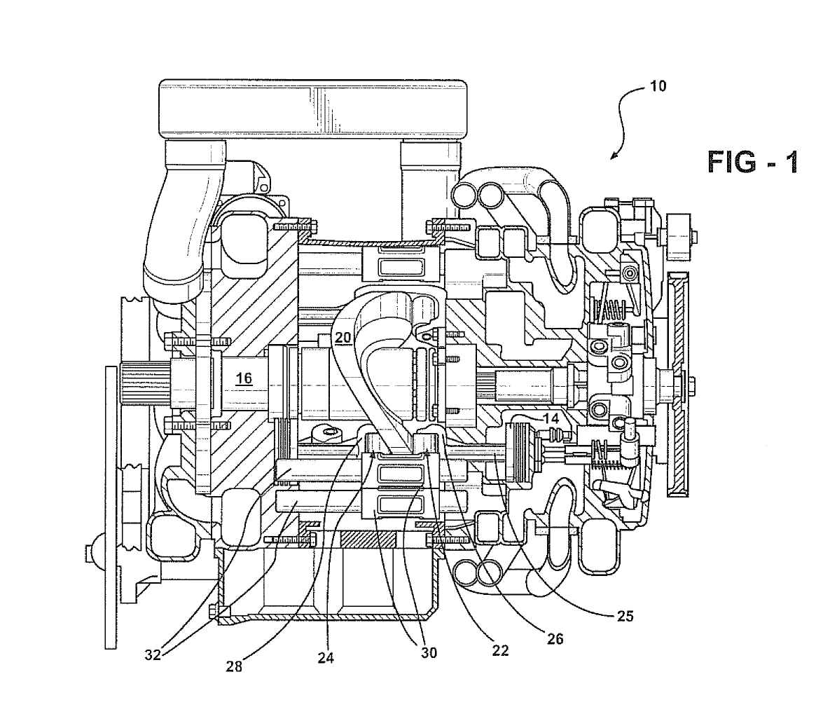

FIG. 1 shows a barrel type internal combustion engine 10 which includes a plurality of pistons 14 arranged concentrically about a central driveshaft assembly 16. Power is transmitted from the pistons 14 to a cam plate 20 via a roller or bearing interface, and the cam plate 20 is coupled to the shaft assembly 16 for rotation therewith about the longitudinal axis of the shaft assembly 16. The cam plate 20 has a generally sinusoidal shape such that the reciprocal movement of the pistons 14 causes corresponding rotational movement of the cam plate 20 and shaft assembly 16.

In the illustrated embodiment, the pistons 14 have connecting rods 25 that extend downwardly and have rollers 22 and 24 which ride on the upper and lower surfaces of the cam plate 20. Alternatively, the pistons 14 may be shaped and positioned such that the rollers form part of the piston.

Rollers may have any form suitable for moveable engagement of the cam plate 20 and piston 14 illustratively including wheels and bearings. Rollers in contact with upper and lower surfaces of the cam plate may have the same or different shape or size.

As will be clear to those of skill in the art, the rollers 22 and 24 experience very high forces in an operating engine. One preferred design makes use of ceramic rollers that are rotatably supported on metal, such as steel, shafts. The ceramic/steel interface provides a bearing surface. The ceramic rollers can substantially reduce the reciprocating weight of a piston assembly. Alternatively, other types of rollers may be used.

One or more rollers may ride in a groove or be otherwise guided along the upper and/or lower surfaces of the cam plate.

Rollers are supported by a support structure shown in partial cutaway view at 26 and 28, the support structure connected to the piston 14. In a preferred option, a support structure substantially encloses the rollers and includes a passage for movement of the cam plate 20 therethrough.

FIG. 1 illustrates guide rods 32 and guide rod supports 30 which together form a guide rod assembly. In cam plate barrel engines, high side loads exist at the point where the pistons communicate with the angled surfaces of the cam plate. This side loading must be reacted somewhere within the piston apparatus without generating unacceptably high levels of friction and wear. Thus, in a preferred embodiment, a guide rod assembly is included in an inventive engine as detailed in U.S. patent application Ser. No. 11/916,624, filed Jul. 15, 2008, which is incorporated herein by reference in its entirety.

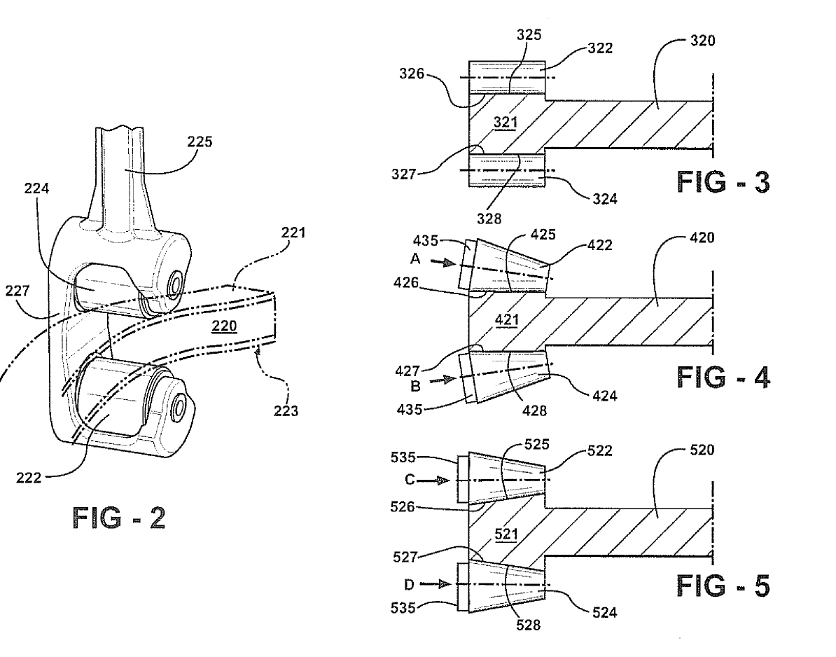

FIG. 2 shows a portion of a cam plate 220 with a pair of rollers 222 and 224 in contact with upper and lower surfaces 221 and 223 of the cam plate 220. It will be appreciated by those of skill in the art that the cam plate typically has a complex shape with an undulating surface. FIG. 2 shows only a small portion of the cam plate. The rollers 222 and 224 are preferably in mechanical communication with connecting rods 225 or pistons (not shown). A support structure 227 is shown for supporting rollers 222 and 224. In the design of FIG. 2, the cam plate 220 has generally parallel upper and lower surfaces 221 and 223 and the rollers 222 and 224 are generally cylindrical. As will be appreciated by those of skill in the art, there may be lash or clearance between the rollers 222 and 224 and the upper and lower surfaces 221 and 223 of the cam plate 220. This is undesirable. A mechanism for application of pressure to a roller to urge the roller towards the cam plate so as to compensate for lash is described in more detail below.

FIG. 3 shows a typical roller in contact with a cam plate. The cam plate 320 includes a roller contact area 321 having generally parallel upper and lower surfaces 325 and 328. The rollers 322 and 324 are generally cylindrical in shape such that they are substantially uniform in diameter viewed in cross section. Lash present between the surfaces 326 and 327 of the rollers 322 and 324 and the upper and lower surfaces 325 and 328 is difficult to compensate since movement of one or both rollers towards the cam plate 321 along the general plane perpendicular to the central axis of the rollers as indicated by the arrows would be difficult to accomplish and would require overcoming high forces between the cam plate and rollers.

FIG. 4 shows an embodiment of a design according to the present invention for compensating for lash. In this design, the cam plate 420 has a roller contact area 421 having generally parallel upper and lower surfaces 425 and 428. The rollers 422 and 424 are frustoconical in shape such that they are generally tapered in cross section. They have outer surfaces 426 and 427. By moving roller 422 along the line indicated by the arrow “A” in the direction of the cam plate any clearance between the surface 425 of the cam plate and the roller 422 will be reduced. Likewise, the roller 424 may also be moved along the general line illustrated by arrow “B” in the direction of the cam plate such that lash is reduced. It is noted that lines “A” and “B” indicate generally the rotational axis of the rollers 422 and 424, respectively. Conversely, either or both rollers may be moved in the opposite direction so as to increase clearance. Again, the rollers 422 and 424 are preferably in mechanical communication with pistons and/or connecting rods. A variety of approaches may be used for moving the roller towards the cam plate to compensate for lash. For example, hydraulic pressure may be used or other means may be used. A force applying mechanism configured to apply such force may be positioned at an outer edge of a roller as shown at 435. Alternatively or additionally an additional mechanism may be provided at the inner edge of the roller to move the roller in the opposite direction or to resist movement of the roller in a direction away from the mechanism 425.

The embodiment of the present invention shown in FIG. 5 has a cam plate 520 that includes a roller contact area 521 with upper and lower surfaces 525 and 528 that are not parallel to one another. Instead, these surfaces are angled away from each other, as shown. Frustoconical rollers 522 and 524 with surfaces 526 and 527 are provided. In this embodiment, the angle of the upper and lower surfaces 525 and 528 on the cam plate 521 and the taper of the rollers 522 and 524 are chosen such that the axes of rotation of the rollers 522 and 524 are generally parallel to one another. Again, the rollers 522 and 524 are preferably in mechanical communication with a piston or connecting rod. If rollers 522 and 524 are moved in the direction indicated by the arrows “C” and “D,” respectively, the clearance or lash between the roller and the cam plate will be reduced. The lines “C” and “D” indicate generally the rotational axis of the rollers 522 and 524, respectively. It is noted that the rotational axes of rollers 522 and 524 are disposed such that they are generally parallel to each other and not parallel to the surface of the rollers. A mechanism configured to apply force along lines “C” and “D” may be positioned at an outer edge of a roller as shown at 535. As with the prior embodiment, a force applying mechanism may be alternatively or additionally provided at the opposite end of the rollers.

As will be clear to those of skill in the art, the angles of the surfaces may be changed, or the configuration may be reversed such that the larger end of the rollers 522 and 524 are to the inside, rather than to the outside of the cam plate. As a further alternative, the angles of the rollers or cam plate may be changed from that illustrated. As an additional alternative, the design may be provided such that the rollers are reversed with respect to each other, such that one has a large end to the inside while the other has a large end to the outside.

As will be clear to those of skill in the art, the linear distance along the cam plate surface depends on the distance from the axis of the cam plate. As such, in an embodiment wherein the thickness of the cam plate is the same at the inner side and outer side of the cam track and cylindrical rollers are used, the rollers will experience a different linear cam track speed at their inner and outer edges. In a preferred embodiment of the present invention, the rollers are tapered at an angle such that the surface speed of the roller at its outer edge matches the linear speed of the cam track at its outer edge while the surface speed of the roller at its inner edge matches the liners speed of the cam track. In other words, the roller is tapered such that there is no scuffing. As will be clear to those of skill in the art, such an angle is likely to be less than the angles illustrated in FIGS. 4 and 5 for a cam plate of typical size. The cam track surfaces may be angled such that the axes of the rollers are parallel, as in FIG. 5 or not parallel as in FIG. 4.

Referring now to FIG. 6, a cam plate is shown at 620. The cam plate 620 has a track portion 621 with an upper surface 634 and a lower surface 636. A first roller bearing assembly 640 is in mechanical communication with the upper surface 634 and a second roller bearing assembly 650 is in mechanical communication with the lower surface 636. Each assembly includes a roller portion 642, 652 supported by a pair of bearings 644, 646, 654, 656. As shown, each roller may be supported on a shaft 647, 657 for rotation about its respective axis of rotation. The roller portion 642 may be moved relative to the bearings 644 and 646 as indicated by the line A. By doing so, the lash between the roller 642 and the surface 634 may be adjusted. The roller 652 may likewise be adjusted. A variety of approaches may be used for moving the roller inwardly and outwardly. For example, hydraulic pressure, or other means may be used. As with the prior embodiments, the geometry of the rollers and cam plate may be changed into any of the variations discussed.

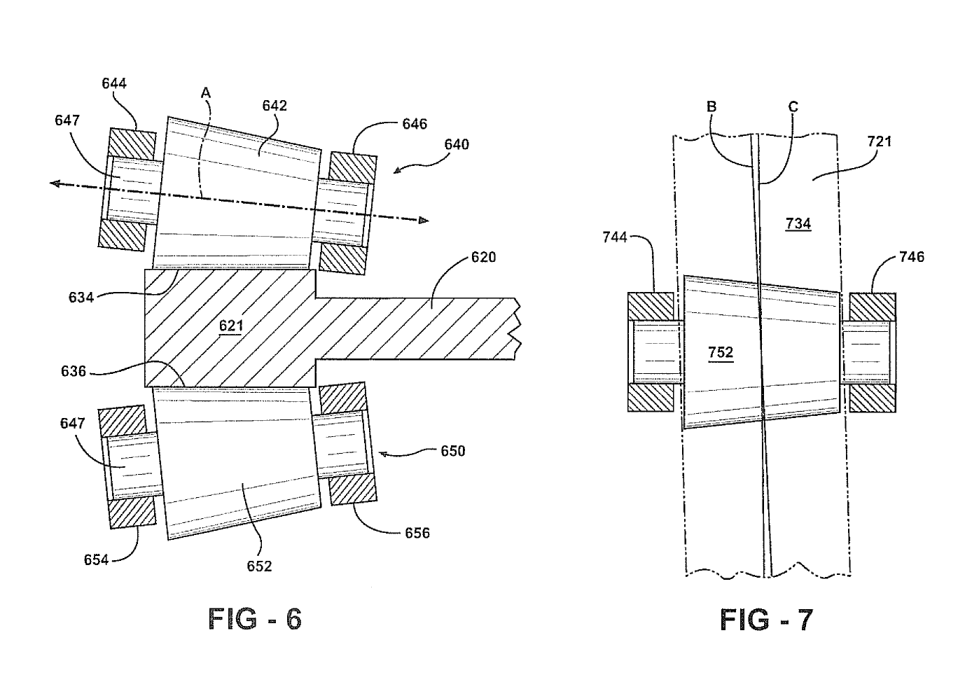

FIG. 7 shows a top view of the track portion 721 of a cam plate with a roller 752, supported by bearings 744 and 746, rolling along the surface 734 of the track 721. Preferably, in a barrel engine, the track 721 is curved when viewed as a top view. However, in FIG. 7 the track 721 is straightened out for ease of illustration. As an alternative to, or in addition to, moving a roller 752 inwardly and outwardly, the roller 752 may be rotated slightly with respect to the track. The line B indicates the centerline of the track 721. By rotating the roller 752 such that its line of travel is along line C the clearance between the roller 752 and the surface 734 will be changed. This can also be used to encourage the roller 752 to move inwardly or outwardly with respect to the track 721.

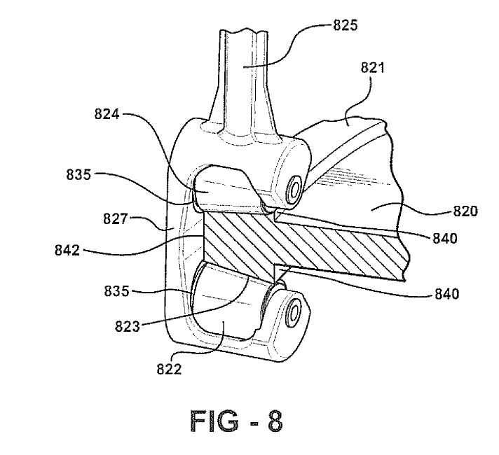

FIG. 8 shows a portion of a cam plate track 820 with a pair of rollers 822 and 824 in contact with upper and lower surfaces 821 and 823 of the cam plate 820. FIG. 8 shows only a small portion of the cam plate track which generally has undulating surfaces. The rollers 822 and 824 are preferably in mechanical communication with connecting rods 825 or pistons (not shown). A support structure 827 is shown for supporting rollers 822 and 824. In the design of FIG. 8, the cam plate 820 has upper and lower surfaces 821 and 823 which are not parallel with respect to each other such that the inner side 840 of the cam plate track is thicker than the outer side 842. The rollers 822 and 824 are frustoconically shaped such that the base of each roller is disposed closer to the outer side 842 of the cam plate track and the top of each roller is proximal to the inner side 840 of the cam plate track. As will be appreciated by those of skill in the art, there may be lash or clearance between the rollers 822 and 824 and the upper and lower surfaces 821 and 823 of the cam plate track 820. Force applying means may be disposed in connection with the roller so as to apply force to a roller, moving it in the direction of the inner side of the cam plate track. Force applying means may further be supported on a support structure for one or more rollers. FIG. 8 shows force applying means at 835. As above, another force applying mechanism may be alternatively or additionally provided at the other end of the roller.

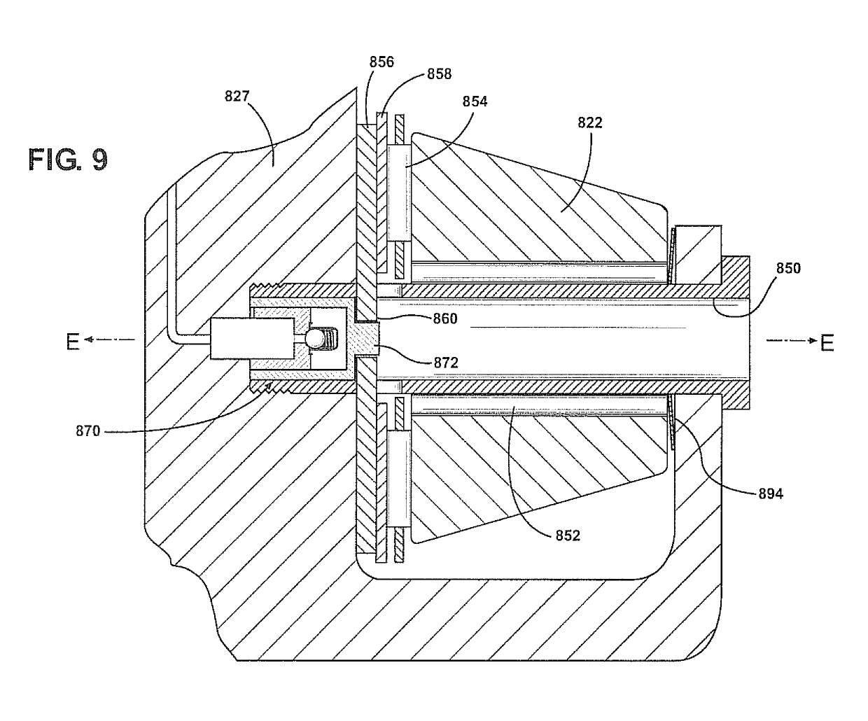

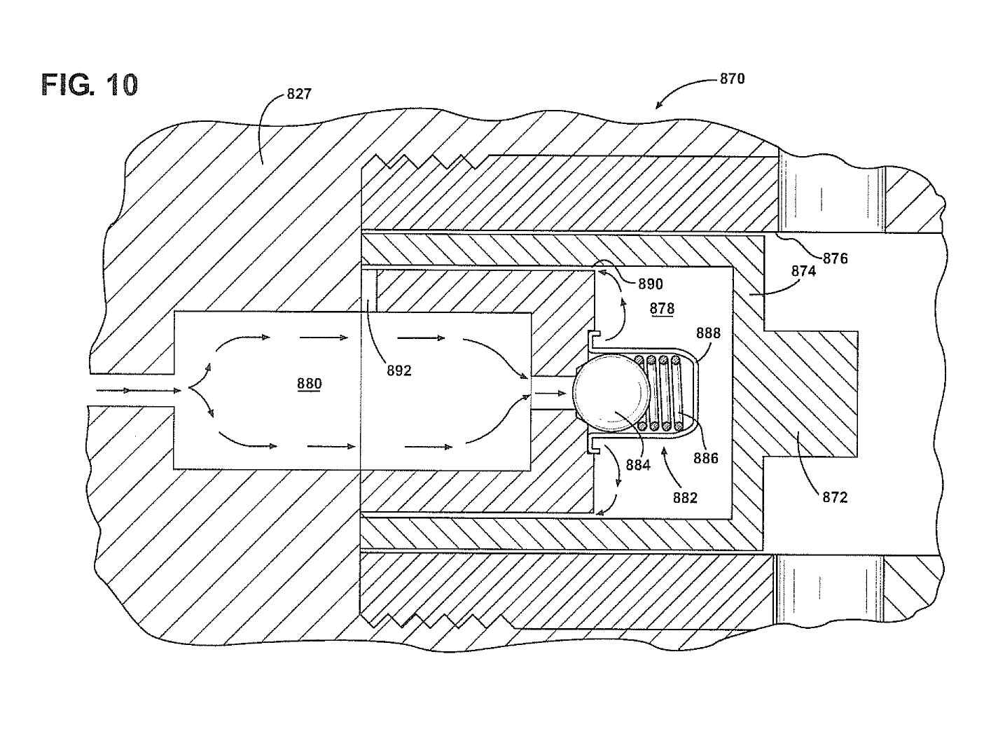

Referring now to FIGS. 9 and 10, one example of a force applying mechanism for use with the present invention will be described. FIG. 9 may be considered to be a cross-sectional view of the lower roller 822 and a portion of the support structure 827 supporting the roller 822. In some preferred embodiments of the present invention, only the lower roller is moved in order to reduce lash. As shown, roller 822 is supported for rotation about an axis E. An axle 850 is coaxial with the axis E and, in the illustrated embodiment, is hollow and fixed (does not rotate). In the illustrated embodiment, the axle 850 takes the from of a hollow bolt that threads into the support structure 827. In order for the roller 822 to rotate on the axle 850, a bearing, such as a roller bearing 852, may be provided between the axle and the roller. As will be clear to those of skill in the art, the tapered roller 822 will try to move to the left, with respect to the view of FIG. 9, due to reactionary forces on the tapered surface of the roller. As such, a thrust bearing is preferably provided between the larger end of the roller 822 and the support structure 827. In the illustrated embodiment, this thrust bearing is illustrated as a roller bearing thrust washer 854. In the illustrated embodiment, a drive plate 856 and a hardened steel washer 858 are disposed between the thrust washer 854 and the support structure 827. The drive plate 856 preferably does not rotate with respect to the support structure 827 and is constructed so as to be strong enough and stiff enough to take the loads from the thrust washer 854. In the illustrated embodiment, the drive plate is generally rectangular and narrow, front to back, and passes through slots in the bolt 850. The drive plate 856 may be disposed in a groove or slot in the support structure 827 that prevents it from rotating. In some embodiments, it may also serve to lock the bolt against rotation. The hardened steel washer 858 provides a wear surface for the thrust washer 854. In the illustrated embodiment, the drive plate 856 has an opening 860 centered on the axis E. In the illustrated embodiment, a hydraulic actuator 870, acting as a force applying mechanism, is disposed in the support structure 827 and has a protrusion 872 extending through the opening 860 in the drive plate 856. The actuator 870 acts to exert a force to the right, with respect to the illustration of FIG. 9. This causes the drive plate to move away from the support structure 827 and urge the roller 822 also to the right. This moves the roller towards the central axis of the cam plate, thereby reducing lash between a surface of the roller and a surface of the cam plate.

Referring now to FIG. 10, a detailed view of the hydraulic actuator 870 is provided. The actuator has a plunger 874, which may include the protrusion 872 that holds the drive plate 856 in position. In the illustrated embodiment, the plunger 874 is received in a recess 876 defined by the axle bolt threaded into the support structure 827. Alternatively, a separate housing may be provided. A high pressure chamber 878 is provided behind or inside the plunger 874 such that pressure in the high pressure chamber 878 urges the plunger 874 to the right. Oil or lubricant from the engine's lubrication system is fed to a low pressure reservoir 880. Delivery of oil to the support structure 827 may be accomplished in accordance with the discussion in the incorporated references. A check valve 882 is formed by a seat in the capsule, a check ball 884 and a check ball spring 886, held in place by a cap 888. The cap is perforated to allow oil to flow into the high pressure chamber. As will be clear to those of skill in the art, the check valve 882 allows oil to flow from the low pressure reservoir 880 into the high pressure chamber 878 when the pressure in the reservoir 880 is sufficient to overcome the spring force and the resistance exerted by the oil in the high pressure chamber 878. As such, as the engine operates and lash is present, the roller 822 can move to the right to take up the lash. This reduces the pressure in the high pressure chamber 878 allowing additional lubricant to flow past the check valve 882 and move the plunger 874 to the right. When force is applied to the roller 822 attempting to move it to the left, the check valve 882 closes and the plunger 874 holds the roller in the reduced-lash position. Preferably, a passage is defined between the high pressure chamber 878 and the low pressure chamber 880 to allow a high pressure lubricant to “leak down” into the low pressure reservoir. This passage may be defined as passage 890 and notch 892 in FIG. 10. As known to those of skill in the art, this combination of feeding lubricant from the low pressure reservoir to the high pressure chamber when a load is reduced on the plunger and the ability of lubricant under pressure to “leak down” will provide a way to reduce lash by urging the roller into a reduced lash position when possible and allowing a slow movement back under force. The resistance of the check valve and the size of the passage allowing the high pressure chamber to “leak down” may be chosen to tune the system for proper performance.

Referring again to FIG. 9, a spring washer 894 may be provided adjacent the small end of the roller so as to maintain the roller in contact with the thrust bearing 854 when other loads are not present. As will be clear to those of skill in the art, the force applying mechanism illustrated in FIGS. 9 and 10 may be used with any of the embodiments of the present invention wherein the roller is moved along its axis of rotation so as to reduce lash.

In a further embodiment, a method according to the present invention is provided for reduction of lash between a roller and a surface. An embodiment of such a method includes providing a system including a cam plate having a track portion for a roller, the track portion having a first surface, a second surface, a thickness between the first and second surface, an inner side, an outer side, and a width between the inner side and the outer side; a first roller in mechanical communication with the first surface of a cam plate track portion to allow rotational engagement of a roller surface with the first surface of the cam plate track portion, the first roller having a rotational axis and a frustoconical shape; and force applying means for moving the first roller towards the center of the cam plate, wherein lash is present between the first roller and the first surface of the cam plate. An inventive method further includes applying force to a first roller, moving the first roller towards the inner side of the cam plate, such that lash between the first roller and the first surface of the cam plate is reduced.

Other embodiments of an inventive method include applying force to a second roller, moving the second roller towards the center of the cam plate, where the provided system further comprises a second roller in mechanical communication with the second surface of a cam plate track portion to allow rotational engagement of a roller surface of the second roller with the second surface of the cam plate track portion, the second roller having a rotational axis and a frustoconical shape, and force applying means for moving the second roller towards the inner side of the cam plate, such that lash between the second roller and the second surface of the cam plate is reduced.

In a preferred embodiment of the present invention, a hydraulic force mechanism is provided for moving the rollers. The hydraulic force mechanism may be provided with pressurized oil from a lubrication system for the engine, or other means may be provided. The hydraulic force mechanism may continuously urge the roller in a direction that will reduce the lash and resist motion in an opposite direction due to the incompressibility of the liquid oil. Also, the force mechanism may “leak down” slowly when the force against the mechanism exceeds the oil pressure in the low pressure chamber.

One skilled in the art will readily appreciate that the present invention is well adapted to carry out the objects and obtain the ends and advantages mentioned, as well as those inherent therein. The apparatus and methods described herein are presently representative of preferred embodiments, exemplary, and not intended as limitations on the scope of the invention. Changes therein and other uses will occur to those skilled in the art. Such changes and other uses are encompassed within the spirit of the invention as defined by the scope of the claims.

1. A lash adjustment system for a roller in a barrel engine of the type having a plurality of combustion chambers each having a piston movable along a piston axis, the lash adjustment system comprising:
a cam plate having a track portion for a roller, the track portion having a first surface, a second surface, a thickness between the first and second surface, an inner side, an outer side, and a width between the inner side and the outer side;
a first roller in mechanical communication with the first surface of a cam plate track portion to allow rotational engagement of a roller surface with the first surface of the cam plate track portion, the first roller having a rotational axis and a frustoconical shape defining a base portion of the first roller having a larger cross-sectional diameter compared to a top portion of the first roller; and
a force applying mechanism in mechanical communication with the first roller, the mechanism operable to move the first roller along the rotational axis so as to reduce lash between the first roller and the first surface of the cam plate.

2. The system of claim 1, wherein the thickness of the cam plate track portion is substantially uniform along the width between the inner side and outer side.

3. The system of claim 1, wherein the thickness of the cam plate track portion proximal to the outer side is smaller than the thickness of the cam plate track portion proximal to the inner side.

4. The system of claim 1, further comprising:
a second roller in mechanical communication with the second surface of a cam plate track portion to allow rotational engagement of a roller surface of the second roller with the second surface of the cam plate track portion, the second roller having a rotational axis and a frustoconical shape defining a base portion of the second roller having a larger cross-sectional diameter compared to a top portion of the second roller.

5. The system of claim 4, wherein the rotational axis of the first roller is substantially parallel to the rotational axis of the second roller.

6. The system of claim 4, wherein the rotational axis of the first roller is substantially parallel to the rotational axis of the second roller.

7. The system of claim 1, further comprising a support structure for housing the first roller, the force applying mechanism being disposed on the support structure such that force is applied to the first roller.

8. The system of claim 1, wherein the force applying mechanism is a hydraulic actuator.

9. A method for reduction of lash between a roller and a surface in a barrel engine of the type having a plurality of combustion chambers each having a piston movable along a piston axis, the method comprising:
providing a system comprising a cam plate having a track portion for a roller, the track portion having a first surface, a second surface, a thickness between the first and second surface, an inner side, an outer side, and a width between the inner side and the outer side;
providing a first roller in mechanical communication with the first surface of a cam plate track portion to allow rotational engagement of a roller surface with the first surface of the cam plate track portion, the first roller having a rotational axis and a frustoconical shape; and
providing a force applying mechanism in mechanical communication with the first roller, wherein lash is present between the first roller and the first surface of the cam plate; and
applying force to a first roller with the force applying mechanism so as to move the first roller along the rotational axis, such that lash between the first roller and the first surface of the cam plate is reduced.

10. A lash adjustment system for a roller in a barrel engine of the type having a plurality of combustion chambers each having a piston movable along a piston axis, the lash adjustment system comprising:
a cam plate having a track portion for a roller, the track portion having a first surface, a second surface, a thickness between the first and second surface, an inner side, an outer side, and a width between the inner side and the outer side;
a first roller supported on a shaft for rotation about a rotational axis, the first roller being in mechanical communication with the first surface of a cam plate track portion to allow rotational engagement of a roller surface with the first surface of the cam plate track portion, the first roller having a frustoconical shape defining a base portion of the first roller having a larger cross-sectional diameter compared to a top portion of the first roller; and
a force applying mechanism in mechanical communication with the first roller, the mechanism operable to move the first roller along the rotational axis so as to reduce lash between the first roller and the first surface of the cam plate.
